(19) United States
(12) Patent Application Publication
(10) Pub. No.: US 2023/0179050 A1
(43) Pub. Date: Jun. 8, 2023

(54) COOLING DEVICE HAVING A DISTRIBUTOR RING DRIVEABLE IN A ROTARY MANNER BY A COOLANT FLOW, AND ELECTRICAL DRIVE UNIT

(71) Applicant: Schaeffler Technologies AG & Co. KG, Herzogenaurach (DE)

(72) Inventors: Jonas Kniel, Karlsruhe (DE); Patrick Gramann, Renchen (DE)

(73) Assignee: Schaeffler Technologies AG & Co. KG, Herzogenaurach (DE)

(21) Appl. No.: 17/911,684

(22) PCT Filed: Feb. 18, 2021
(86) PCT No.: PCT/DE2021/100158

§ 371 Date: Sep. 15, 2022

(30) Foreign Application Priority Data
Mar. 18, 2020 (DE) 10 2020 107 376.3

(51) Int. Cl. H02K 1/32; H02K 9/19

(52) U.S. Cl. CPC H02K 1/32; H02K 9/19

(57) ABSTRACT

A cooling device for an electrical drive unit, includes a static feed element which has a coolant feed. The coolant feed has at least one supply channel running along a longitudinal axis of the feed element and multiple outlet channels which are distributed around a circumference of the feed element, run transversely to the supply channel, and emerge from the feed element. A distributor ring, which can rotate relative to the feed element and is designed for coolant distribution, is held on the feed element. The distributor ring is designed and adapted to the outlet channels of the feed element such that the distributor ring is driven directly in a rotary manner by a coolant flow emerging from the outlet channels during operation.

### CROSS-REFERENCE TO RELATED APPLICATIONS

This application is the U.S. National Phase of PCT Appln. No. PCT/DE2021/100158 filed Feb. 18, 2021, which claims priority to DE 10 2020 107 376.3 filed Mar. 18, 2020, the entire disclosures of which are incorporated by reference herein.

### TECHNICAL FIELD

The disclosure relates to a cooling device for an electrical drive unit, with a static feed element having a coolant feed, wherein the coolant feed has at least one supply channel running along a longitudinal axis of the feed element and multiple arranged distributed along a circumference of the feed element, extending transverse/inclined to the supply channel and exiting from the feed element. The disclosure also relates to an electrical drive unit having this cooling device.

### BACKGROUND

Generic cooling devices are already sufficiently known in the prior art. For example, DE 10 2018 117 939 A1 discloses an electrical drive in which an electric motor is cooled via an oil circuit in the transmission. In this case, centrifugal cooling is essentially implemented, in which a rotating component, preferably a central shaft, is provided with through holes, through which coolant is flung outwards in a radial direction during operation due to the centrifugal force acting and is thus distributed to the corresponding components of the electric motor.

In this embodiment known from the prior art, however, it has been found that the cooling oil cannot be further distributed when the oil-carrying shaft is at a standstill. Thus, the corresponding components are only selectively cooled—if at all—due to the settling oil sump. Overheating can therefore occur locally at the uncooled areas. Furthermore, the design of the oil distribution in the rotating shaft is relatively complex in these designs. Here, for example, the questions to be resolved are at which speed and which oil pressure how much oil comes out of which bore/through hole. This determination makes the manufacture of the corresponding shaft relatively complex.

There are also cooling devices in which the coolant streams are directed along specific areas of the electrical machine. However, even when these devices are in operation, selective cooling occurs only at previously selected locations of the electrical machine. An example of this is DE 10 2015 007 588 A1.

### SUMMARY

It is therefore the object of the present disclosure to provide a cooling device which is as simple as possible and which enables efficient cooling which is independent of the speed of rotating drive shafts.

According to the disclosure, this is achieved in that a distributor ring, which can be rotated relative to the feed element and is designed for coolant distribution, is accommodated on the feed element, wherein the distributor ring is designed and matched to the outlet channels of the feed element in such a way that the distributor ring is directly rotationally driven by a coolant flow emerging from the outlet channels during operation.

By providing the rotatable distributor ring on the feed element, a cooling device is provided that also functions independently of other components of the drive train that rotate during operation and consequently cools the drive unit effectively even when it is at a standstill. By rotating the distributor ring accordingly, the coolant is distributed over a large area in order to cool the relevant components as effectively as possible. Furthermore, the design of the cooling device is kept as simple as possible.

Further advantageous embodiments are explained in more detail below.

Accordingly, it is also advantageous if the distributor ring is designed in such a way that it deflects the coolant (preferably oil) emerging from the outlet channels during operation in such a way that the coolant exits from the distributor ring in a radial direction and/or an axial direction (the longitudinal axis) towards an environment. As a result, the coolant is distributed over a large area during operation.

In addition, it has proven to be expedient if the feed element and/or the distributor ring is/are annular. As a result, the cooling device can be integrated in the drive unit in the most space-saving manner possible.

Furthermore, it is advantageous if the feed element is provided directly by an area fixed to the housing. This further simplifies the construction.

For a simply constructed bearing and design of the distributor ring, it has also proven to be advantageous if this is rotatably mounted on an axial end of the feed element. More preferably, the distributor ring is mounted on an axially projecting (preferably also annular) bearing area of the feed element. In this way the installation space requirements are further reduced.

If the distributor ring is supported in the axial direction relative to the feed element, the distributor ring is also supported axially in the simplest possible way.

For efficient coolant distribution, it has also been found to be expedient if the distributor ring has a first wall region arranged radially outside the feed element with respect to the longitudinal axis of the feed element and/or a second wall area arranged radially inside the feed element (with respect to the longitudinal axis).

If the first wall area and/or the second wall area has/have multiple radial through holes distributed in the circumferential direction, effective cooling of the corresponding components is realized both radially inside and radially outside of the distributor ring.

For a robust design of the distributor ring, it is also expedient if the distributor ring has an essentially U-shaped cross section.

If the outlet channels of the feed element are set in the circumferential direction (obliquely), the drive of the distributor ring during operation is made possible in the simplest possible way. As a result, the coolant exits both in the radial direction and obliquely in the circumferential direction to the inside or outside of the feed element and, at a distance from the feed element, meets corresponding opposing areas of the distributor ring. These opposing areas are preferably implemented as corresponding guide vanes or recesses on/in the distributor ring. As a result, the structure of the distributor ring is likewise realized as simply as possible.

Furthermore, the disclosure relates to an electrical drive unit for a hybrid or purely electrical drive train of a motor vehicle, having an electrical machine and a cooling device according to the disclosure according to at least one of the embodiments described above, wherein the cooling devices arranged at least with the distributor ring radially inside or radially outside at least one component of the electrical machine.

In other words, fluid cooling, preferably driven by fluid pressure, is implemented by means of a rotating ring (distributor ring). The pressure of the cooling fluid is used to rotate the other component in the form of the distributor ring and distribute the coolant over a large surface/area around a fluid outlet point. More specifically, the ring (distributor ring) is fitted on a fluid-conducting component to distribute the cooling fluid over a corresponding area. The cooling fluid is injected into the ring at specific points so that the ring is rotated by the off-center injection and the corresponding contours on the ring. Holes are also made in the ring through which the coolant can be discharged to the outside or inside. When the ring is set in rotation by the pressure of the cooling fluid, the holes in the ring also rotate, of course, so that the coolant is distributed over a large area. This allows the coolant to be distributed throughout the ring, wherein the ring is driven solely by the pressure of the coolant fluid.

### BRIEF DESCRIPTION OF THE DRAWINGS

In the following, the disclosure is now explained in more detail with reference to figures.

In the figures:

FIG. 1 shows a longitudinal sectional representation of a cooling device according to the disclosure according to a preferred exemplary embodiment, as it is already used in a partially shown electrical drive unit, wherein the structure of the cooling device is shown in detail on the part of a feed element and a distributor ring mounted so as to rotate thereon,

FIG. 2 shows a longitudinal section of the cooling device used in FIG. 1 with the flow of coolant that occurs during operation illustrated by flow arrows,

FIG. 3 shows a cross sectional view of a circumferential area of the cooling device according to FIGS. 1 and 2, wherein the section is selected in such a way that both two through holes penetrating the distributor ring in the radial direction and multiple outlet channels formed in the feed element can be seen,

FIG. 4 shows a cross sectional view of the cooling device similar to FIG. 3, wherein the coolant flow exiting the outlet channels during operation is indicated by flow arrows, and

FIG. 5 shows a cross sectional view of the cooling device similar to FIGS. 3 and 4, wherein multiple recesses made in the distributor ring can now also be seen.

### DETAILED DESCRIPTION

The figures are merely schematic in nature and are therefore intended solely for the purpose of understanding the disclosure. The same elements are provided with the same reference signs.

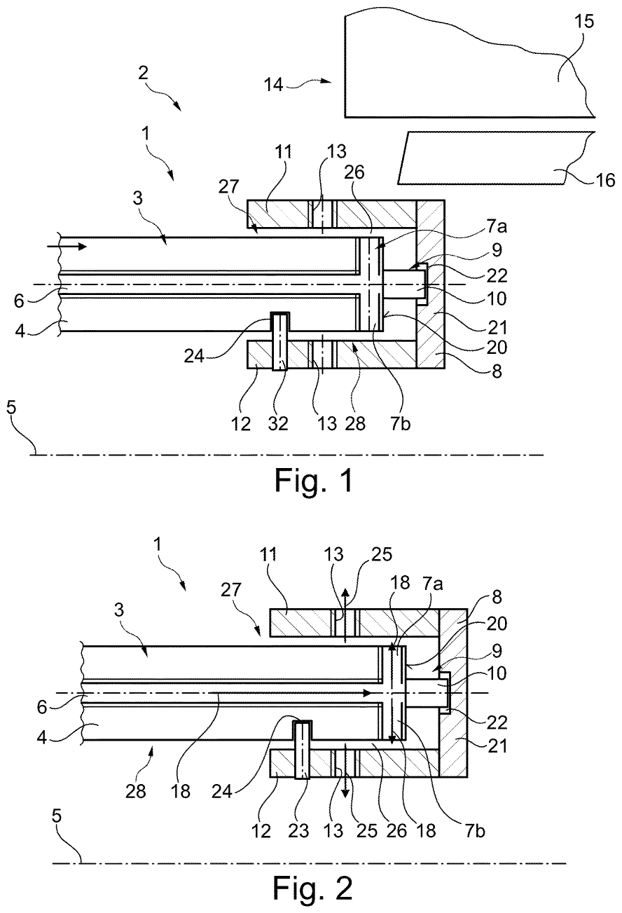

FIG. 1 shows a basic structure of an electrical drive unit 2 having a cooling device 1 according to the disclosure. The electrical drive unit 2 is typically used during operation in a drive train of a motor vehicle (not shown in detail for the sake of clarity). This motor vehicle drive train can be implemented either purely electrically or in a hybrid manner. An electrical machine 14 provided in the electrical drive unit 2 drives the motor vehicle in a corresponding electric or hybrid operating mode. FIG. 1 shows the stator 15 and rotor 16 of the electrical machine 14 in a highly simplified manner.

According to the disclosure, the cooling device 1 is accommodated in a space in the electrical drive unit 2. During operation, the cooling device 1 cools the components, preferably the stator 15 and/or the rotor 16, of the electrical machine 14 by generating a coolant flow. The cooling device 1 is accommodated in a housing of the electrical machine 14 (not shown in more detail for the sake of clarity). For this purpose, the cooling device 1 has a feed element 4 which is statically and therefore fixedly attached to the housing of the electrical machine 14 or is formed directly by this housing.

As can be seen clearly in FIG. 1, the feed element 4 is essentially annular. The feed element 4 runs annularly around a central longitudinal axis 5. The directions axial, radial and circumferential used here refer to this longitudinal axis 5. An axial direction/axial is therefore to be understood as a direction along the longitudinal axis 5, a radial direction/radial as a direction perpendicular to the longitudinal axis 5, and a circumferential direction as a direction along a circular line concentric to the longitudinal axis 5.

The feed element 4, as can be seen in more detail in FIG. 1, has a coolant feed 3. In particular, an axially running supply channel 6 of the feed element 4 can be seen in FIG. 1. In this way, multiple supply channels 6 are distributed in the circumferential direction in the feed element 4. The respective supply channel 6 transitions towards a free end 9 of the feed element 4 into two outlet channels 7a and 7b. A first outlet channel 7a runs radially outwards from the supply channel 6 and emerges from the feed element 4 towards a radial outer side 27 of the feed element 4. A second outlet channel 7b extends in the radial direction from the supply channel 6 inwards and emerges from the feed element 4 towards a radial inner side 28 of the feed element 4. The supply channel 6 is essentially designed as a blind hole and thus ends in front of an axial end face 20 of the feed element 4.

An annular distributor ring 8 is also rotatably received on the feed element 4. The distributor ring 8 is arranged centered on the longitudinal axis 5. The distributor ring 8 is rotatably mounted/supported on the feed element 4 about the longitudinal axis 5 (/axis of rotation). In addition, the distributor ring 8 is supported in the axial direction relative to the feed element 4.

As can be seen in more detail in this respect with FIGS. 1 and 2, the feed element 4 has an axial extension in the form of a bearing area 10 for rotatably supporting the distributor ring 8. In this embodiment, this bearing area 10 is realized in the form of a ring and thus runs completely around in the circumferential direction of the feed element 4. A side wall 21 of the distributor ring 8 that runs radially/is arranged axially next to the feed element 4 has a depression 22 that also runs annularly and is open axially toward the feed element 4 and that receives the bearing area 10 in a sliding manner. The depression 22 is realized as a groove. The bearing area 10 thus slides off in the depression 22 when the distributor ring 8 rotates relative to the feed element 4.

A locking pin 23/locking bolt is provided for axially locking the distributor ring 8. This locking pin 23, which more preferably can also be provided multiple times in the circumferential direction, is anchored, on the one hand, in the distributor ring 8 and, on the other hand, rotatably/slidably mounted in an annular circumferential recess 24 in the form of a groove 24. The locking pin 23 is radially oriented and thus secured/supported by the sides of the recess 24 in the axial direction relative to the feed member 4.

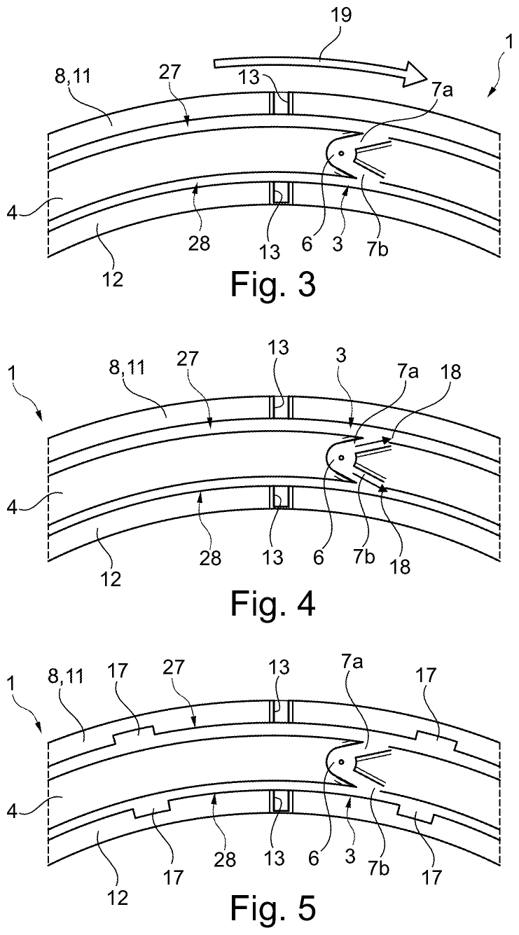

Furthermore, as can be seen particularly well in connection with FIGS. 3 to 5, the distributor ring 8 is designed in such a way that a coolant flow emerging from the outlet channels 7a, 7b during operation, as indicated by the corresponding arrows 18, hits the distributor ring 8 in such a way that the distributor ring 8 is directly rotationally driven thereby.

Accordingly, the distributor ring 8 is provided with fluid bypass sections omitted in FIGS. 3 and 4 for the sake of clarity, which ensure that the coolant flow 18 exiting radially outwards and radially inwards from the feed element 4 as shown in FIG. 4 causes the rotation of the distributor ring 8. For this purpose, it is shown in more detail in FIG. 5 by way of example that the fluid deflection sections are preferably designed as multiple recesses 17 distributed in the circumferential direction, which are made on the radial regions of the distributor ring 8 facing the feed element 4. When the coolant flow 18 strikes the peripheral side flanks of the recesses 17, the impulse of the coolant flow 18 is passed on to the distributor ring 8 and this is driven in rotation (according to the rotational direction arrow 19 in FIG. 3).

As also shown in FIG. 4, the outlet channels 7a, 7b are positioned in the circumferential direction and are consequently positioned at an angle when viewed in the radial direction in order to transmit an impulse to the distributor ring 8 in the circumferential direction. It should be pointed out in particular that the distributor ring 8 can also be realized in other ways in other versions, in particular with regard to its fluid deflection section, which is more preferably also realized as integral or separately attached conveying blades.

As can be seen in FIGS. 1 and 2, the distributor ring 8 has an essentially U-shaped cross section. The distributor ring 8 has a first wall area 11 in the form of an outer wall area and a second wall area 12 in the form of an inner wall area. The two wall areas 11, 12 are offset from one another in the radial direction and are coupled to one another via the side wall 21. The first wall area 11 is arranged radially outside/towards the radial outer side 27 of the feed element 4, whereas the second wall area 12 is arranged radially inside/towards the radial inner side 28 of the feed element 4. The two wall areas 11 cover the feed element 4, in particular in a section having the outlet channels 7a, 7b.

The wall areas 11, 12 and the side wall 21 form a distribution space 26 with the feed element 4, in which the coolant flowing out of the outlet openings 7 during operation is collected, distributed and passed on. The wall areas 11, 12 are each provided with the recesses 17 on their radial side facing the feed element 4. These recesses 17 are located in the usual way axially at the level of the outlet channels 7a, 7b.

The distributor ring 8 is provided both on its radial inner side and on its radial outer side, i.e., both on the side of its first wall area 11 and on the side of its second wall area 12, with multiple radial through holes 13 distributed in the circumferential direction. These through holes 13 discharge the coolant, as indicated in FIG. 2, and thus generate a (discharged) cooling flow 25 which flows through the electrical drive unit 2. The through holes are arranged axially offset to the outlet channels 7a, 7b.

In other words, according to the disclosure, a fluid pressure is used to rotate another component (distributor ring 8) in order to distribute the cooling fluid over a large area around the fluid outlet point. This idea is implemented in that a ring 8 is applied to the fluid-carrying component 4, which is intended to distribute the cooling fluid over a large area. The cooling fluid is introduced into the ring 8 at certain points and is intended to cause the ring 8 to rotate by eccentric introduction and corresponding contours 17 in the ring 8. A few holes 13 are in turn made in the ring 8, as a result of which the cooling fluid can be thrown outwards, or also outwards and inwards. Due to the fact that the ring 8 is set in rotation by the fluid pressure, these holes 13 in the ring 8 also rotate and thus a planar distribution of the cooling fluid is realized. Thus, a possibility is created to distribute cooling fluid over a wide area around the ring 8, wherein the ring 8 is driven solely by the fluid pressure. The design of how much fluid is distributed by this assembly is also much simpler than with known centrifugal cooling systems, since there is no influence of the speed of the transmission and the design of how much fluid gets there can be carried out statically in the system.

As can be seen in FIG. 1, fluid is supplied via a static part 4. This part 4 should be a rotationally symmetrical ring. The guide ring 10 is at the end 9 of the static part 4. The distributor ring 8 is placed on this ring 10, which can rotate freely as a result. The distributor ring 8 is fixed against axial movement via a bolt 23 or the like, which is fitted in a bore in the distributor 8 and protrudes into a groove 24 in the static part 4.

In FIG. 2 it can be seen how the fluid is introduced into the distributor ring 8 and is guided to the points to be cooled via bores 13 distributed around the circumference of the ring 8. The bores 7a, 7b on the static component are to be offset from the axis of rotation 5 in order to accelerate the distributor ring 8.

As can be seen in FIGS. 3 to 5, the distributor ring 8 is accelerated through the bores 7a, 7b from the static component 4, as a result of which the fluid is distributed uniformly over the circumference. Depending on the pressure, the distributor ring 8 can be provided with contours 17 or the like; for example, in order to create a better contact surface for the fluid.

### LIST OF REFERENCE SYMBOLS

1 Cooling device

2 Electrical drive unit

3 Coolant feed

4 Feed element

5 Longitudinal axis

6 Supply channel

7 Outlet opening

7a First outlet channel

7b Second outlet channel

8 Distributor ring

9 End

10 Bearing area

11 First wall area

12 Second wall area

13 Through hole

14 Electrical machine

15 Stator

16 Rotor

17 Recess

18 Flow arrow

19 Rotational direction arrow

20 End face

21 Side wall

22 Depression

23 Locking pin

24 Recess

25 Cooling flow

26 Distribution space

27 Outer side

28 Inner side

1. A cooling device for an electrical drive unit, comprising: a static feed element which has a coolant feed, wherein: the coolant feed has at least one supply channel running along a longitudinal axis of the feed element and multiple outlet channels which are distributed around a circumference of the feed element, run transversely to the supply channel, and emerge from the feed element, wherein a distributor ring, which can rotate relative to the feed element and is designed for coolant distribution, is held on the feed element, wherein the distributor ring is designed and adapted to the outlet channels of the feed element such that the distributor ring is driven directly in a rotary manner by a coolant flow emerging from the outlet channels during operation.

2. The cooling device according to claim 1, wherein the distributor ring is designed in such a way that it deflects the coolant emerging from the outlet channels during operation in such a way that the coolant exits from the distributor ring in a radial direction or an axial direction towards an environment.

3. The cooling device according to claim 1, wherein the feed element or the distributor ring is annular.

4. The cooling device according to claim 1, wherein the distributor ring is rotatably mounted on an axial end of the feed element.

5. The cooling device according to claim 1, wherein the distributor ring is supported in an axial direction relative to the feed element.

6. The cooling device according to claim 1, wherein the distributor ring has a first wall area arranged radially outside the feed element with respect to the longitudinal axis of the feed element or a second wall area arranged radially inside the feed element.

7. The cooling device according to claim 6, wherein the first wall area or the second wall area has multiple radial through holes distributed in a circumferential direction.

8. The cooling device according to claim 1, wherein the distributor ring has a U-shaped cross section.

9. The cooling device according to claim 1, wherein the outlet channels of the feed element are set in a circumferential direction.

10. An electrical drive unit for a hybrid or purely electrical drive train of a motor vehicle, comprising an electrical machine and a cooling device comprising a static feed element having a coolant feed, wherein: the coolant feed has at least one supply channel running along a longitudinal axis of the feed element and multiple outlet channels which are distributed around a circumference of the feed element, run transversely to the supply channel, and emerge from the feed element, wherein a distributor ring, which can rotate relative to the feed element and is designed for coolant distribution, is held on the feed element wherein the distributor ring is designed and adapted to the outlet channels of the feed element such that the distributor ring is driven directly in a rotary manner by a coolant flow emerging from the outlet channels during operation, wherein the cooling device is arranged at least with the distributor ring radially inside or radially outside at least one component of the electrical machine.
